(19) United States
(12) Patent Application Publication
(10) Pub. No.: US 2024/0326663 A1
(43) Pub. Date: Oct. 3, 2024

(54) ABUTTING AND BEARING DEVICE AND SEATING DEVICE

(71) Applicant: WONDERLAND SWITZERLAND AG, Steinhausen (CN)

(72) Inventors: Zhengwen GUO, Steinhausen (CH); Ruyi LI, Steinhausen (CH)

(73) Assignee: WONDERLAND SWITZERLAND AG, Steinhausen (CN)

(21) Appl. No.: 18/554,747

(22) PCT Filed: Apr. 11, 2022
(86) PCT No.: PCT/EP2022/059598

§ 371 Date: Oct. 10, 2023

(30) Foreign Application Priority Data
Apr. 12, 2021 (CN) 202110389499.X

(51) Int. Cl. B60N 2/28

(52) U.S. Cl. CPC B60N 2/2824

(57) ABSTRACT

An abutting and bearing device and a seating device, wherein the abutting and bearing device includes: a casing; an abutting member disposed in the casing and having an end extending out of the casing, a driving assembly disposed in the casing, and the abutting member being movable so as to be in its extended position or retracted position by the driving assembly; and a control member disposed on the casing for controlling an extension of the abutting member, wherein the abutting and bearing device further includes a locking assembly and a resetting assembly, the locking assembly is used to lock the abutting member when the abutting member is extended, and the resetting assembly is used to reset the abutting member to its retracted position.

### CROSS-REFERENCE TO RELATED APPLICATIONS

This application is a 371 U.S. National Phase of International Application No. PCT/EP2022/059598, filed on Apr. 11, 2022, which claims priority to Chinese Application No. 202110389499.X, filed on Apr. 12, 2021, which are incorporated herein by reference in their entirety.

### TECHNICAL FIELD

The present application relates to an abutting and bearing device, and a seating device including the abutting and bearing device. In particular, the application relates to a seating device for a child safety seat and its abutting and bearing device.

### BACKGROUND

A child safety seat is a device specially designed for children of different weights or ages. Children will be restrained in the safety seats during travelling, so in the case of a car collision or sudden deceleration, the impact on them can be reduced and their bodies can be restricted, thereby effectively improving safety of children in travelling.

Moreover, in order to more effectively improve safety of the child safety seat and prevent the child safety seat from overturning, it is necessary to adjust fit degree between the child safety seat and the car seat back. In the prior art, the adjustment is mostly performed indirectly by adjusting a length of ISOFIX. However, such an adjustment range is very limited and cannot meet the use requirements in practice.

In the prior art, a base body connected to the car seat is provided, and the child safety seat may be embedded on the base body to avoid overturning. For example, a child safety seat and its adjustment mechanism are provided, which includes an ejector rod engaging block, a locking member, and a driving member. The ejector rod engaging block is slidably arranged on the base along a first direction and is detachably engaged with an ejector rod. The locking member is slidably arranged on the base along a second direction and is detachable engaged with the ejector rod engaging block. The driving member is slidably arranged on the base along the second direction and is connected to the ejector rod engaging block. When the locking member is disengaged from the ejector rod engaging block, the driving member may drive the ejector rod engaging block to slide along the first direction so that it is disengaged from the ejector rod, and the angle of the ejector rod can be adjusted. The ejector rod and the car seat back may be fitted with each other, and the leg accommodation space can be adjusted, so as to make the seating of infants and young children more comfortable.

In the above child safety seat of the prior art, although the angle of the ejector rod can be adjusted to make the child safety seat fit the car seat back more closely, and after ISOFIX fixes the child safety seat, the child safety seat may swing from side to side due to insufficient fixation and insufficient support. Furthermore, the above child safety seat according to the prior art also has other problems as follows. First, the adjustment mechanism is complicated, it is necessary to involve connection cooperation and movement cooperation of components in at least two directions, so its manufacturing and assembling are difficult, and its cost is high. In addition, the adjustment operation is complicated, it is necessary to take the cooperation of multiple components into account and perform operations in multiple directions, so operation failures are prone to occur. Furthermore, none of the adjustment mechanisms in the prior art can realize the automatic resetting of the ejector rod, thusly making the adjustment and disassembly of the adjustment mechanism cumbersome and time-consuming.

### SUMMARY

In view of the above problems, a purpose of the application is to provide an abutting and bearing device and a seating device including the abutting and bearing device, wherein the abutting and bearing device can make the seating device and the car seat back tightly fit to each other, and can realize detachment of the seating device from the car seat in an easier and simpler manner, so as to facilitate disassembling and readjustment.

For this, according to a solution of the application, an abutting and bearing device is provide, which includes: a casing; an abutting member disposed in the casing and having an end extending out of the casing, a driving assembly disposed in the casing, and the abutting member being movable by the driving assembly, so as to be in its extended position or retracted position; and a control member disposed on the casing for controlling an extension of the abutting member, wherein the abutting and bearing device further includes a locking assembly and a resetting assembly, the locking assembly is used to lock the abutting member when the abutting member is extended, and the resetting assembly is used to reset the abutting member to its retracted position.

Wherein the casing includes an upper cover and a lower cover connected to each other.

Wherein the control member is a control knob, a control push button, or a control button.

Wherein the control member is provided by two, and a cross bar is disposed between the two control members.

Wherein the driving assembly includes a driving member and a connecting arm, the driving member is connected to the control member, the connecting arm is connected to the abutting member so that the abutting member is able to move in translation, and the driving member is pivotally connected to the connecting arm.

Wherein the abutting and bearing device further includes a fixing member, and the fixing member fixes the driving assembly and the control member.

Wherein a sliding sleeve is covered on an outer side of the abutting member, and an abutting spring is disposed between the abutting member and the sliding sleeve.

Wherein the sliding sleeve is connected to the connecting arm, and a pin is disposed on the sliding sleeve at a position where the sliding sleeve is connected to the connecting arm, the connecting arm includes a slot, the pin is installed in the slot, the abutting member is pushed out or pulled back as the pin slides in the slot, when the abutting member is pushed out, the abutting spring is in a compressed state, the locking assembly includes a locking member and a locking groove, the locking member is connected to the abutting member, and the locking groove is arranged on the casing.

Wherein the abutting member is connected to the connecting arm, and a pin is disposed on the abutting member at a position where the abutting member is connected to the connecting arm, the connecting arm includes a slot, and the pin is installed in the slot.

Wherein the locking assembly includes a locking member and a locking groove, the locking member is connected to the abutting member, and the locking groove is arranged on the casing.

Wherein the locking member has a first beveled edge, the locking groove has a second beveled edge cooperative with the first beveled edge, and when the locking member falls into or slides out of the locking groove, the first beveled edge slides along the second beveled edge.

Wherein the locking groove is provided by a plurality.

Wherein the locking member includes a sliding pin, and the abutting member includes an inclined slot, the sliding pin is able to slide in the inclined slot.

Wherein the resetting assembly includes a torsion spring, one end of the torsion spring is fixed on the casing, and the other end of the torsion spring is fixed on the driving member.

Wherein the resetting assembly includes a resetting button, a traction member and a torsion spring, one end of the traction member is connected to the resetting button, and the other end of the traction member is connected to the locking member, one end of the torsion spring is fixed on the casing, and the other end of the torsion spring is fixed on the driving member.

Wherein the resetting assembly further includes a button reset spring disposed on the resetting button.

Wherein the driving assembly includes a driving member and a connecting arm, the driving member is connected to the control member, and the connecting arm is slidably connected to the abutting member so that the abutting member is able to pivotally move.

Wherein the abutting member includes an abutting end and a connecting end, the connecting end includes a slot, and the connecting arm is arranged in the slot.

Wherein the locking assembly includes a locking block disposed on the casing, and a locking protrusion cooperative with the locking block, when the abutting member is in the extended position, the locking protrusion abuts against a lower end of the locking block, thereby locking the abutting member in the extended position.

Wherein the resetting assembly includes a push button and a resetting spring, the locking protrusion is arranged on the push button, one end of the resetting spring is connected to the abutting member, and the other end of the resetting spring is connected to the casing.

Wherein the resetting assembly further includes a push button spring disposed on the push button.

Wherein the driving assembly includes a driving member and a connecting member fixedly connected to each other, the driving member is connected to the control member, and the connecting member is connected to the abutting member so that the abutting member is able to pivotally move.

Wherein the driving member and the connecting member are integrally formed.

Wherein the control member is provided by two, a cross bar is disposed between the two control members, and the driving member of the driving assembly is connected to the cross bar.

Wherein the abutting member is L-shaped, and a lower end of the abutting member includes a pin, the driving member includes a slot, and the pin is inserted through the slot.

Wherein the locking assembly includes a locking member, a locking rod, and a driving rod, the locking member is connected to the abutting member, and the driving rod cooperates with the locking rod such that the locking rod is locked to or unlocked from the locking member through a pivoting of the driving rod.

Wherein the locking member includes a plurality of toothed slots for accommodating the locking rod.

Wherein the resetting assembly includes a push button and a resetting spring, the driving rod is connected to the push button, one end of the resetting spring is connected to the abutting member, the other end of the resetting spring is connected to the casing, and the resetting spring normally maintains a state of pulling back the abutting member, and the driving rod is pivoted by the push button, thereby unlocking the locking rod from the locking member.

According to another solution of the application, a seating device is provided, which includes a body and the aforementioned abutting and bearing device, the sitting device is able to abut against a car seat back through the abutting and bearing device, and is able to be automatically unlocked from abutting against the car seat back.

### BRIEF DESCRIPTION OF THE DRAWINGS

The accompanying drawings are included herein to provide a further understanding of the disclosure, and are incorporated into this specification to constitute a part of this specification. The accompanying drawings illustrate embodiments of the disclosure, and are used together with the following description to illustrate the concept of the disclosure.

In the drawings:

FIG. 1 is a schematic view showing a structure of a child safety seat according to the first embodiment of the application;

FIG. 2 is a schematic view showing a structure of an abutting and bearing device according to the first embodiment of the application;

FIGS. 3 and 4 are schematic views respectively showing the structure of the abutting and bearing device according to the first embodiment of the application, wherein FIG. 3 shows the abutting member is in an extended state, and FIG. 4 shows the abutting member is in a retracted state;

FIGS. 5 and 6 are schematic views respectively showing the structure of the abutting and bearing device according to the first embodiment of the application, and the driving assembly in FIGS. 5 and 6 are in different working positions;

FIG. 7 is a schematic view showing a simplified structure of a driving assembly of the abutting and bearing device according to the first embodiment of the application;

FIGS. 8 and 9 are schematic views respectively showing the structure of the abutting and bearing device according to the first embodiment of the application;

FIGS. 10 and 11 are schematic views respectively showing the structure of the abutting and bearing device according to the second embodiment of the application, wherein FIG. 10 shows the abutting rod assembly in a retracted, and FIG. 11 shows the abutting rod assembly is in an extended state;

FIGS. 12 and 13 are schematic views respectively showing the structure of the abutting and bearing device according to the second embodiment of the application, and the driving assembly in FIGS. 12 and 13 are in different working positions;

FIGS. 14 and 15 are schematic views respectively showing a structure of a locking assembly of the abutting and bearing device according to the second embodiment of the application;

FIG. 16 is a schematic view showing a structure of a resetting assembly of the abutting and bearing device according to the second embodiment of the application;

FIGS. 17 and 18 are schematic views respectively showing the structure of the abutting and bearing device according to the third embodiment of the application, wherein FIG. 17 shows the abutting member in a retracted state, and FIG. 18 shows the abutting member in an extended state;

FIG. 19 is a schematic view showing a specific structure of the abutting and bearing device according to the third embodiment of the application;

FIG. 20 is a schematic view showing the locking assembly of the abutting and bearing device according to the third embodiment of the application;

FIG. 21 is a schematic view showing a locking state of the locking assembly of the abutting and bearing device according to the third embodiment of the application;

FIG. 22 is a schematic view showing the resetting assembly of the abutting and bearing device according to the third embodiment of the application;

FIGS. 23 and 24 are schematic views respectively showing the structure of the abutting and bearing device according to the fourth embodiment of the application, wherein FIG. 23 shows the abutting member in a retracted state, and FIG. 24 shows the abutting member in an extended state;

FIG. 25 is a schematic view showing a simplified structure of the abutting and bearing device according to the fourth embodiment of the application, wherein the abutting member is shown in different retracted and extended states;

FIGS. 26 and 27 are schematic views respectively showing a detailed structure of the abutting and bearing device according to the fourth embodiment of the application, wherein FIG. 26 shows the abutting member in a retracted state, and FIG. 27 shows the abutting member in an extended state;

FIGS. 28 and 29 are schematic views respectively showing the structure of the abutting and bearing device according to the fifth embodiment of the application, wherein FIG. 28 shows the abutting member in an extended state, and FIG. 29 shows the abutting member in a retracted state;

FIG. 30 is a schematic view showing the structure of the driving assembly of the abutting and bearing device according to the fifth embodiment of the application; and

FIGS. 31 and 32 are schematic views respectively showing the structure of the locking assembly of the abutting and bearing device according to the fifth embodiment of the application, wherein the locking assembly in FIGS. 31 and 32 are in different working positions.

### DETAILED DESCRIPTION

Hereinafter, exemplary embodiments will be described in detail with reference to the accompanying drawings. Although the disclosure is susceptible to various modifications and alternatives, specific embodiments thereof are shown by way of example in the accompanying drawings. However, the disclosure should not be construed as being limited to the embodiments set forth herein, but on the contrary, the disclosure will cover all modifications, equivalents, and alternatives that fall within the spirit and scope of the embodiments.

The following detailed description of the application is mainly carried out by taking the seating device as a child safety seat and its abutting and bearing device as an example, but the seating device according to the application may also be other devices. The abutting and bearing device according to the application, for example, may closely fit the child safety seat to a car seat, and adjustment and disassembling can be easily performed.

In the abutting and bearing device according to the application and the seating device comprising the abutting and bearing device, the abutting and bearing device can make the seating device and the car seat back achieve a close fit, thereby making connection between the seating device and the car seat more stable and more safe, and avoiding overturning accidents. In addition, the abutting and bearing device according to the application further has an automatic reset function, which can realize detachment of the seating device from the car seat in an easier and simpler manner, so as to facilitate disassembling and readjustment.

The abutting and bearing device and the child safety seat according to the application will be described in detail below by referring to the accompanying drawings.

### First Embodiment

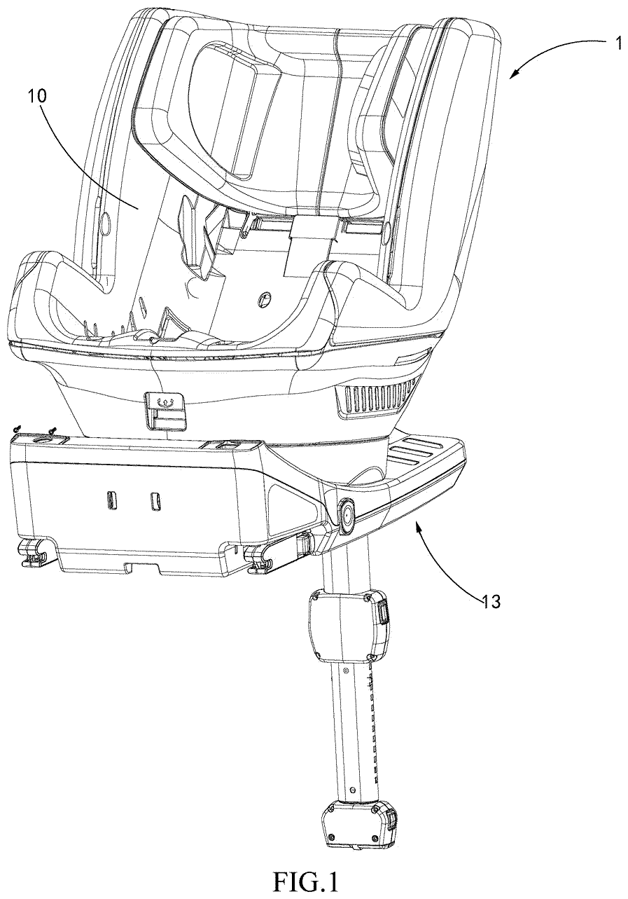

Firstly, referring to FIGS. 1-9, the child safety seat and its abutting and bearing device according to a first embodiment of the application will be described.

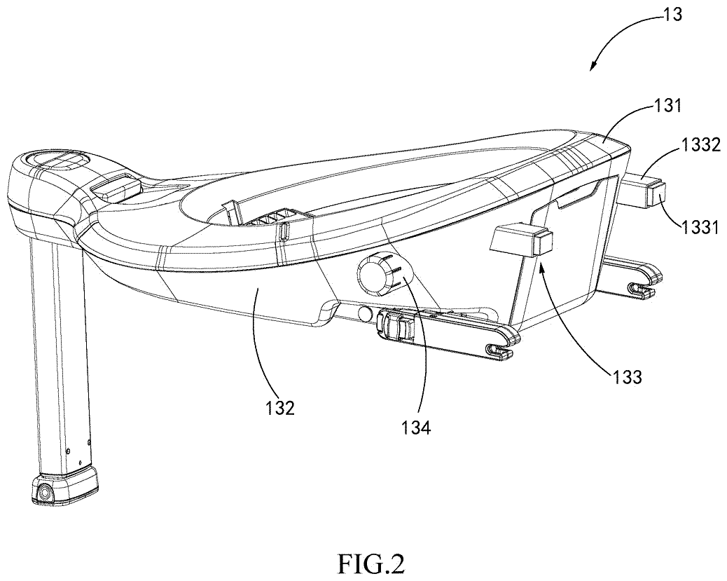

FIG. 1 shows a schematic view of a structure of a child safety seat 1 according to the first embodiment of the application. The child safety seat 1 mainly includes a body 10 for providing a seating space for a child. In order to better connect the child safety seat 1 to a car seat, so as to avoid the safety accident of overturning, an abutting and bearing device 13 according to the application is also provided. The abutting and bearing device 13 is mounted on the car seat, and the child safety seat 1 is embedded on the abutting and bearing device 13. As shown in FIG. 2, which is a schematic view showing a structure of the abutting and bearing device 13 according to the first embodiment of the application, the abutting and bearing device 13 includes an upper cover 131 and a lower cover 132. The upper cover 131 and the lower cover 132 can be connected together. Of course, a casing part of the abutting and bearing device 13 may also be formed into an integrated structure. An abutting member 1331 is disposed in the casing of the abutting and bearing device 13, for example, it may also be disposed in the lower cover 132 in this embodiment. As shown, the abutting member 1331 extends out of the lower cover 132, and the movement of the abutting member 1331 may be controlled by a control member, so as to be in an extended position or a retracted position. The shown control member is a control knob 134, of course, other forms of control member, such as a control button or a control push button, are feasible. The control knob 134 shown in the figure is arranged on the lower cover 132.

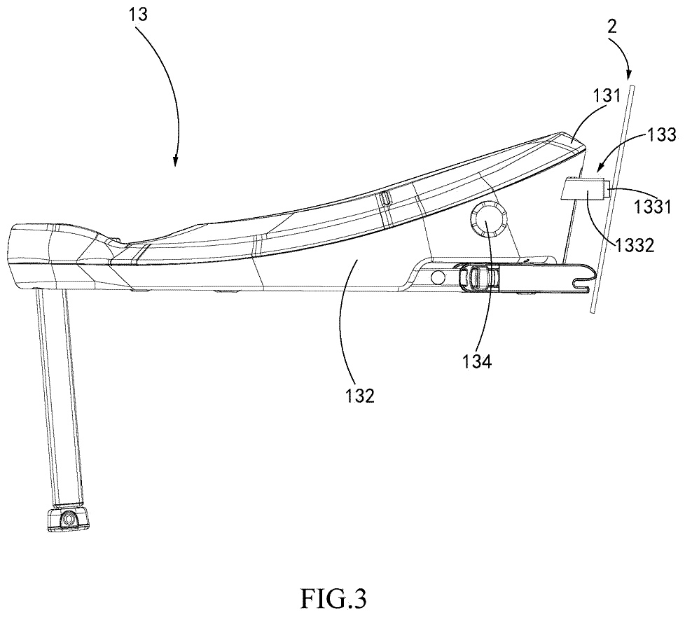

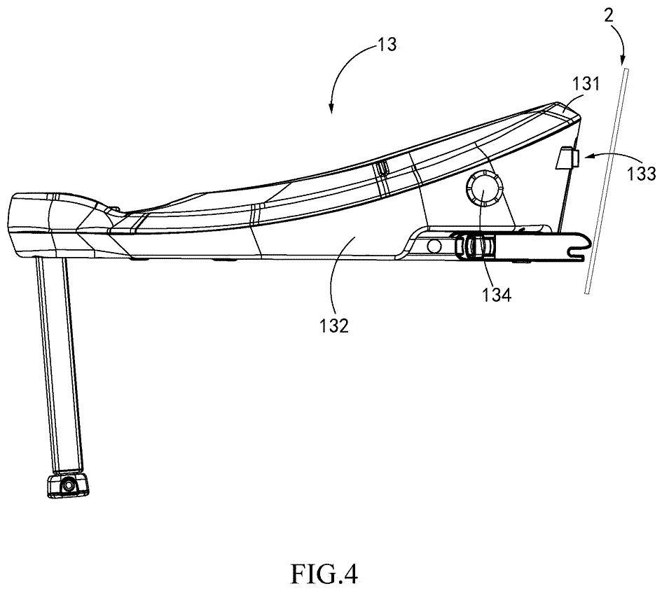

Additionally referring to FIGS. 3 and 4. FIGS. 3 and 4 are schematic views respectively showing the structure of the abutting and bearing device 13 according to the first embodiment of the application, wherein FIG. 3 shows the abutting member 1331 in an extended state, and FIG. 4 shows the abutting member 1331 in a retracted state. By rotating the control knob 134, for example, in a clockwise direction, the abutting member 1331 may be extended, so as to achieve a tight abutment with the car seat back 2. The abutting and bearing device 13 according to the embodiment may also retract the abutting member 1331 when, for example, the child safety seat needs to be disassembled or a position adjustment needs to be performed, as shown in FIG. 4. At this time, the abutting member 1331 is disengaged from the abutment with the car seat back 2.

In order to enable the abutting member 1331 to be extended and retracted under the control of the control knob 134, the abutting and bearing device 13 according to this embodiment further includes a driving assembly 135, a locking assembly 138, and a resetting assembly 139. A detailed description will be provided below.

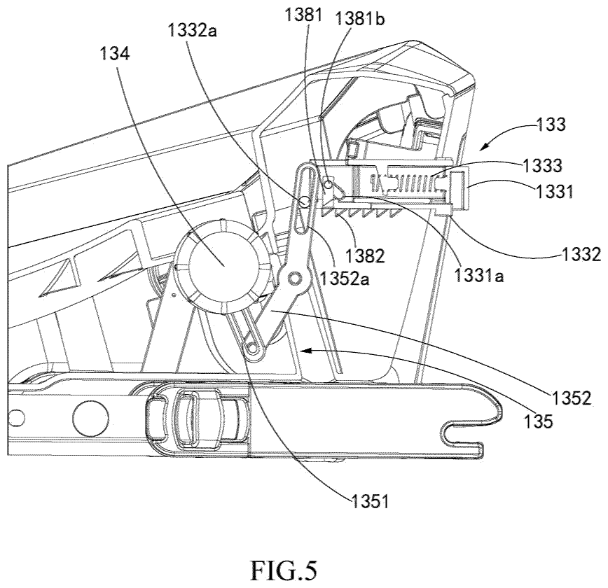

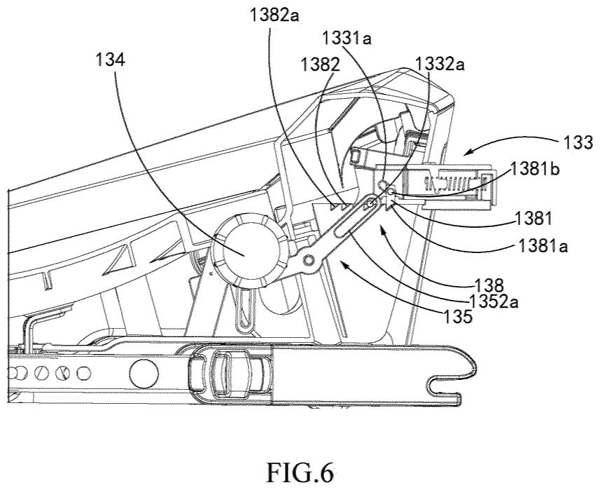

As shown in FIGS. 5 and 6, which are schematic views respectively showing the structure of the abutting and bearing device 13 according to the first embodiment of the application, and the driving assembly 135 in FIGS. 5 and 6 are in different working positions. The shown driving assembly 135 includes a driving member 1351 and a connecting arm 1352. The driving member 1351 is connected to the control knob 134. The connecting arm 1352 is connected to the abutting member 1331, such that the abutting member 1331 can move in translation. Furthermore, the driving member 1351 is pivotally connected to the connecting arm 1352.

In addition, according to the first embodiment, a sliding sleeve 1332 is set on an outer side of the abutting member 1331, and an abutting spring 1333 is disposed between the abutting member 1331 and the sliding sleeve 1332. The abutting member 1331, the sliding sleeve 1332 and the abutting spring 1333 together form an abutting rod assembly 133. In addition, according to this embodiment, the sliding sleeve 1332 is connected with the connecting arm 1352, a pin 1332a is disposed on a lower end of the sliding sleeve 1332 at a position where the sliding sleeve 1332 is connected to the connecting arm 1352, the connecting arm 1352 includes a slot 1352a, and the pin 1332a is installed in the slot 1352a. When, for example, the control knob 134 is rotated clockwise, the driving member 1351 is driven to be pivoted clockwise, and in turn the connecting arm 1352 is pulled to be pivoted clockwise. At this time, since the pin 1332a would slide along the slot 1352a, the sliding sleeve 1332 is pushed to move rightward, such that the abutting member 1331 is pushed to move rightward, and finally the abutting member 1331 is in the extended position under driving of the driving assembly 135 through the control knob 134, as shown in FIG. 6. Likewise, during the process the abutting member 1331 is pulled back, the pin 1332a would slide in an opposite direction in the slot 1352a.

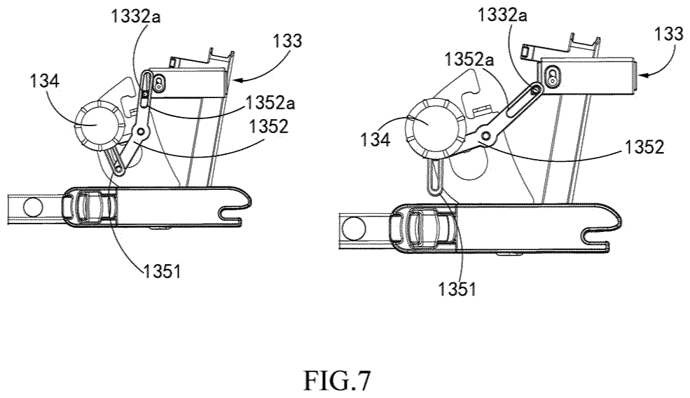

FIG. 7 is a schematic view showing a simplified structure of the driving assembly 135 according to the first embodiment of the application, from which the action process of the driving member 1351 and the connecting arm 1352 of the driving assembly 135 during the extension of the abutting rod assembly 133 can be seen more clearly. In this embodiment, when the abutting rod assembly 133 is at its maximum extended position, the pin 1332a is located, e.g., at an end of the slot 1352a, but the invention is not limited thereto.

Referring to FIG. 6 again, which also shows the locking assembly 138 according to this embodiment. As shown, the locking assembly 138 includes a locking member 1381 and a locking groove 1382, wherein the locking member 1381 is connected to the abutting member 1331, and the locking groove 1382 is arranged on the lower cover 132. Preferably, as shown, the locking member 1381 has a first beveled edge 1381a, and the locking groove 1382 has a second beveled edge 1382a cooperative with the first beveled edge 1381a. Moreover, the locking groove 1382 may be provided by a plurality.

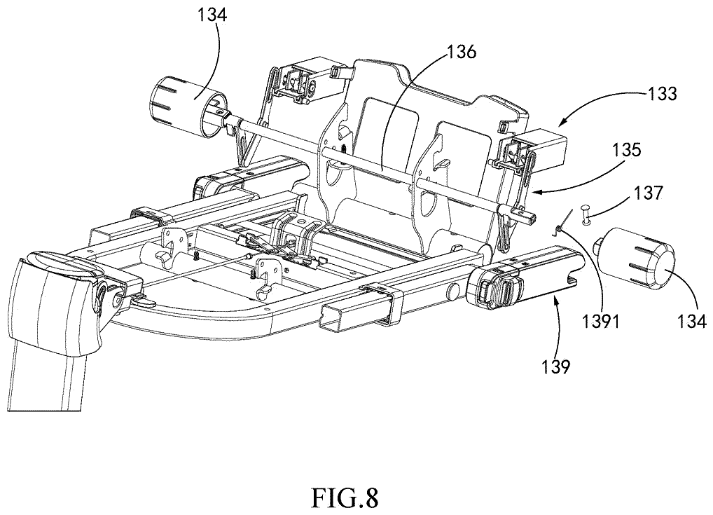

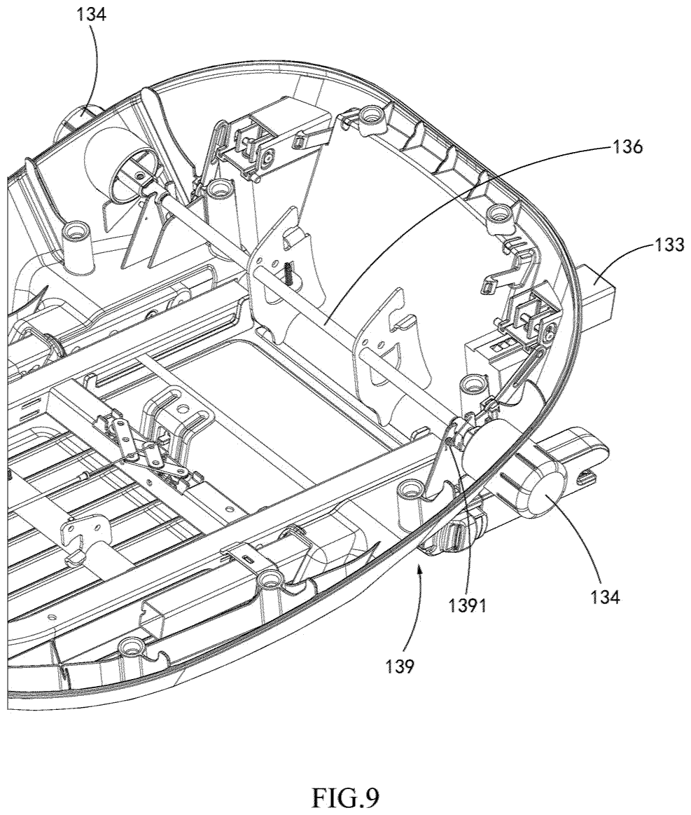

The abutting and bearing device 13 according to this embodiment further includes a resetting assembly 139. As shown in FIGS. 8 and 9, the resetting assembly 139 mainly includes a torsion spring 1391. One end of the torsion spring 1391 is fixed on the lower cover 132, and the other end of the torsion spring 1391 is fixed on the driving assembly 135. The torsion spring 1391 normally maintains the state of pulling the driving assembly 135 back.

The locking process and the unlocking and resetting process of the locking assembly 138 according to this embodiment will be described in detail by referring to FIGS. 5 and 6. The locking member 1381 further includes a sliding pin 1381b, and correspondingly, the abutting member 1331 includes an inclined slot 1331a, and the sliding pin 1381b may slide in the inclined slot 1332b. In the illustrated example, the inclined slot 1332b is arranged to be inclined from the upper left to the lower right. Of course, other inclinations manners are also feasible. Specifically, when the abutting member 1331 starts to move rightward under driving of the driving assembly 135, the locking member 1381 is raised at this time, such that the abutting member 1331 can smoothly move rightward until the abutting member 1331 abuts the car seat back 2. Moreover, while the abutting member 1331 is abutting the car seat back 2, the abutting member 1331 is pushed back, that is, to be moved left by a small amount. At this time, the sliding pin 1381b moves downward and rightward along the inclined slot 1332b, and falls into the locking groove 1382, so the abutting member 1331 is locked in its extended position. During the process the locking member 1381 is falling into the locking groove 1382, the first beveled edge 1381a of the locking member 1381 will slide along the second beveled edge 1382a of the locking groove 1382, so as to smoothly enter into the locking groove 1382 under guidance of the first beveled edge 1381a and the second beveled edge 1382a, thusly locking the abutting member 1331 to be closely fitted with the car seat back 2, and even if the control knob 134 is released, the abutting member 1331 will still maintain an extended abutment state. Since the locking groove 1382 is provided by a plurality, the abutting member 1331 can be locked in extended state at multiple positions.

When the abutting member 1331 is pushed out and locked in its extended state, the abutting spring 1333 between the abutting member 1331 and the sliding sleeve 1332 is in a compressed state. Therefore, once the abutting member 1331 leaves abutting state of the car seat back 2, under pushing of the abutting spring 1333 in a compressed state, the abutting member 1331 will move rightward slightly, and this time the sliding pin 1381b will be pushed to move upwardly and leftwardly along the inclined slot 1332b, such that the locking member 1381 is raised again and disengaged from the locking groove 1382. At this time, under the action of the torsion spring 1391, the driving assembly 135 rotates counterclockwise, thereby bringing the abutting member 1331 to return to its retracted position. When the locking member 1381 slides out of the locking groove 1382, the first beveled edge 1381a still slides along the second beveled edge 1382a, so as to be smoothly raised out of the locking groove 1382 under guidance of the first beveled edge 1381a and the second beveled edge 1382a.

The abutting and bearing device 13 according to this embodiment has two control knobs 134 on the left and right, and has a cross bar 136 arranged between the two control knobs 134 to synchronize actions of the two control knobs 134. In addition, as shown in FIG. 8, the abutting and bearing device 13 is further provided with a fixing member 137 for fixing the driving assembly 135 and the control knob 134.

The abutting and bearing device 13 according to this embodiment can realize the extension of the abutting member 1331 by simply operating the control knob(s). In addition, when the abutting member 1331 is in the extended position, such extended state can be locked by using the locking assembly 138, so as to prevent the abutting member 1331 from being retracted unexpectedly. Moreover, when disassembling and position adjustment need to be carried out, the locking assembly 138 can be unlocked in a simple manner, and the abutting member 1331 can be automatically retracted, for example, through the resetting assembly 139.

### Second Embodiment

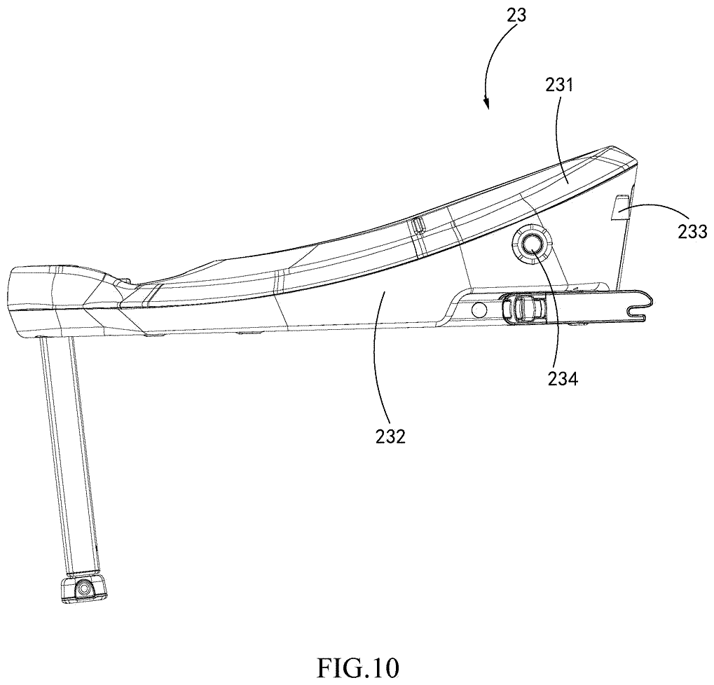

The second embodiment according to the application will be described below by referring to FIGS. 10-16. The components in the second embodiment which are different from those in the first embodiment as well as their connection relationships and operation modes will be emphatically described below.

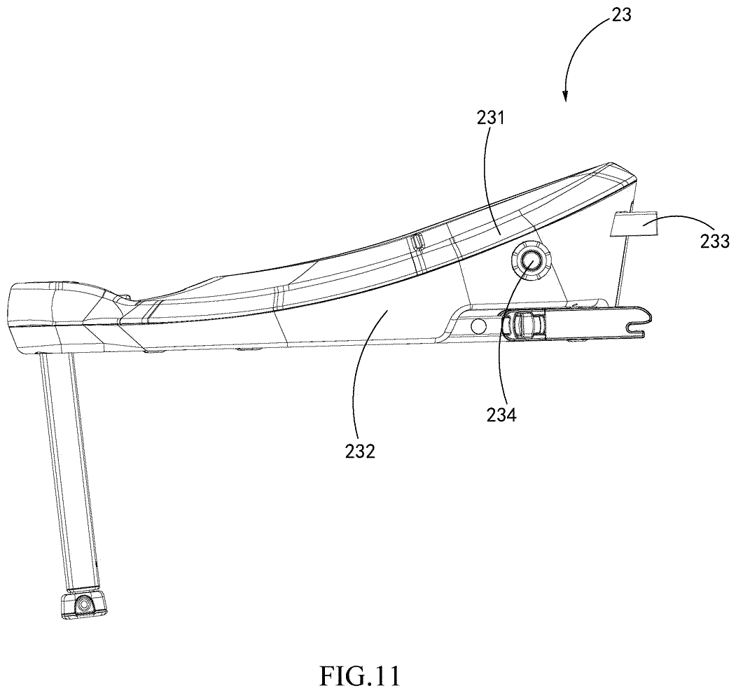

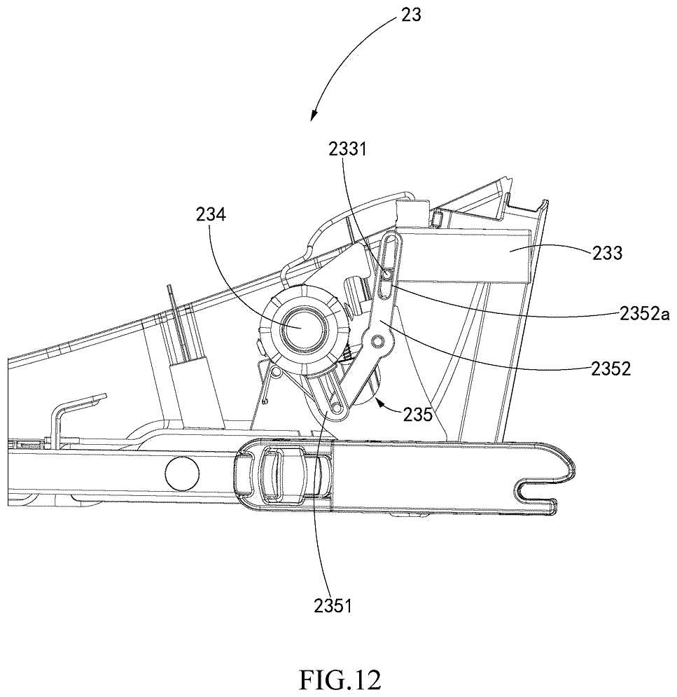

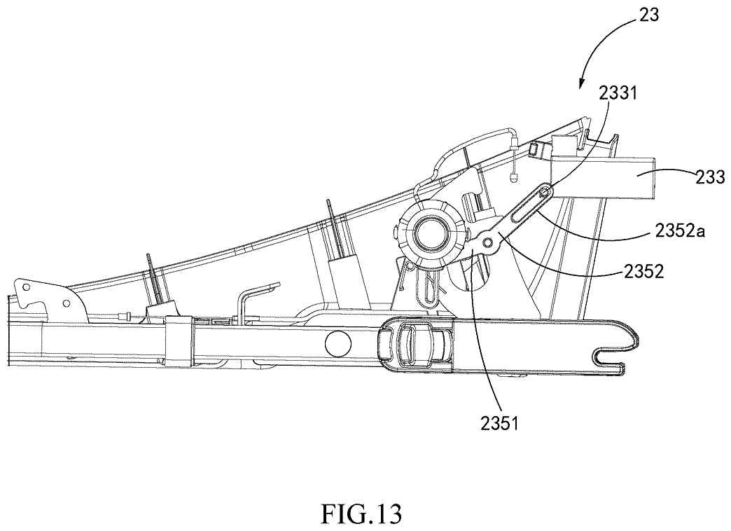

Referring to FIGS. 10, 11, the abutting and bearing device 23 according to the second embodiment also includes an upper cover 231 and a lower cover 232. An abutting member 233 extends from the lower cover 232, and can be in its extended position under driving of a driving assembly 235, and can be in its retracted position by unlocking and resetting of a resetting assembly 239. Likewise, referring to FIGS. 12, 13, the driving assembly 235 includes a driving member 2351 and a connecting arm 2352, and a slot 2352a is disposed on the connecting arm 2352. A pin 2331 is disposed on the abutting member 233, and the pin 2331 is arranged in the slot 2352a. By rotating the control knob 234, the abutting member 233 can be located in its extended position. Likewise, a cross bar 236 is provided to synchronize the movements of the two control knobs 234.

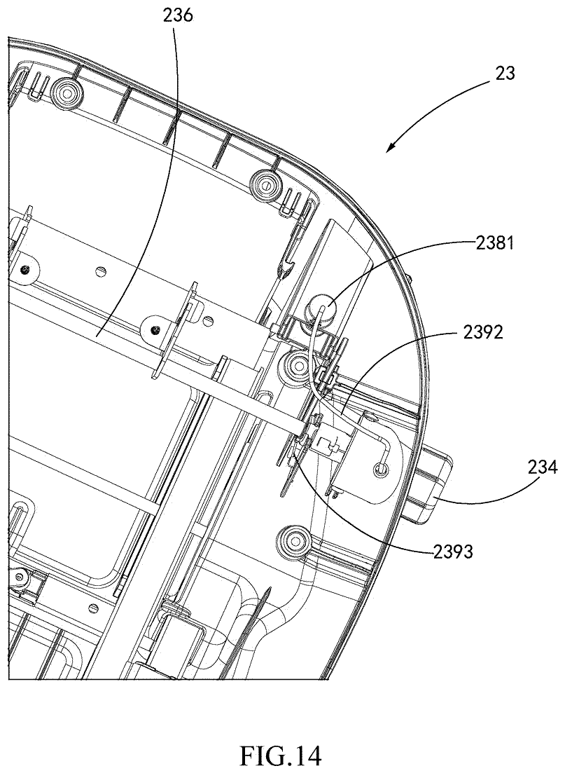

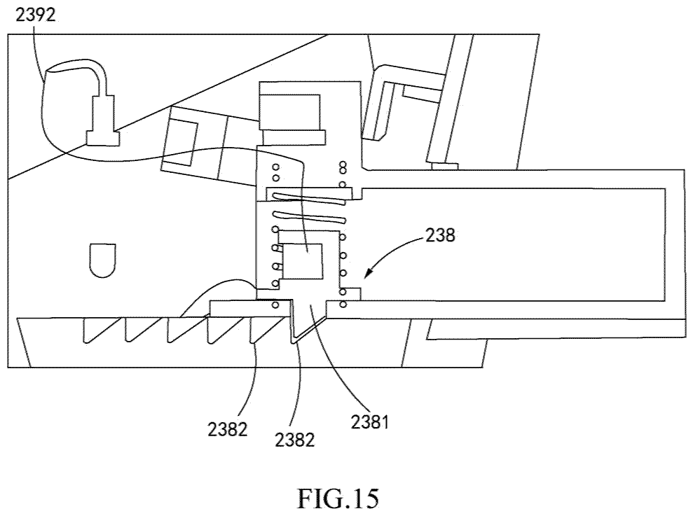

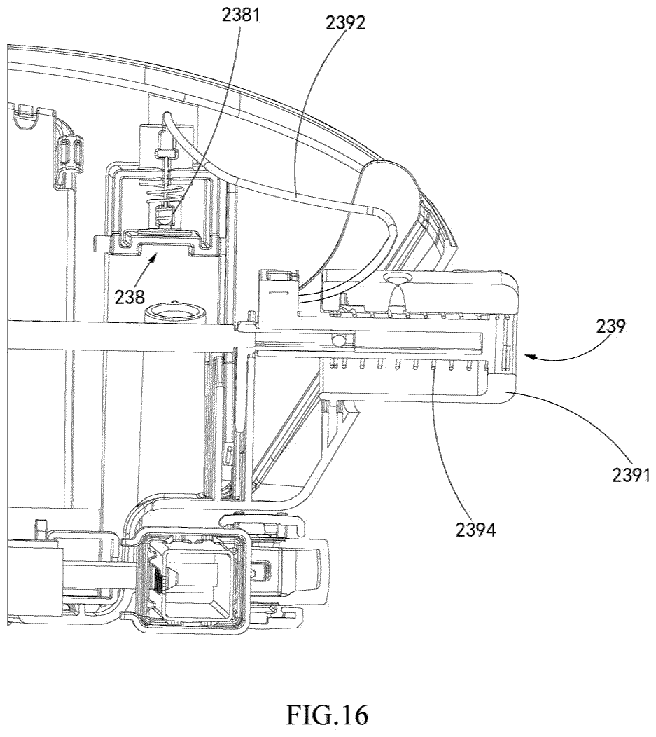

The locking assembly 238 and the resetting assembly 239 according to the second embodiment as well as their operation modes will be described in detail below by referring to FIGS. 14, 15, 16. Among them, FIGS. 14 and 15 are schematic views respectively showing a structure of the locking assembly 238 of the abutting and bearing device 23 according to the second embodiment of the application; FIG. 16 is a schematic view showing a structure of the resetting assembly 239 of the abutting and bearing device 23 according to the second embodiment of the application.

The locking assembly 238 includes a locking member 2381 and a locking groove 2382. The locking member 2381 is connected to the abutting member 233, and the locking groove 2382 is arranged on the lower cover 232. The locking member 2381 can fall into the locking groove 2382 to lock the abutting member 233 in an extended state, and similar to the first embodiment, the locking member 2381 and the locking groove 2382 may be provided with beveled edges cooperative to each other to guide their mutual movement, and details will not be repeated here.

The resetting assembly 239 includes a resetting button 2391, a traction member 2392, and a torsion spring 2393 (shown in FIG. 14). One end of the traction member 2392 is connected to the resetting button 2391, and the other end of the traction member 2392 is connected to the locking member 2381. One end of the torsion spring 2393 is fixed on the lower cover 232, and the other end of the torsion spring 2393 is fixed on the driving member 2351. Moreover, the torsion spring 2393 normally maintains pulling back the driving member 2351. In addition, preferably, the resetting assembly 239 further includes a button reset spring 2394 disposed on the resetting button 2391.

After the abutting member 233 is extended, if the abutting member 233 is required to be in the retracted position, what needed is only to press the resetting button 2391 in the direction of the arrow shown in FIG. 16, and the resetting button 2391 will push one end of the traction member 2392, thereby the other end of the traction member 2392 will lift the locking member 2381 in an upward direction to leave the locking groove 2382, such that the locked state of the locking assembly 238 is unlocked. In such state, under the action of the torsion spring 2393, the driving member 2351 is pulled back, such that the abutting member 233 is in its retracted position.

The abutting and bearing device 23 according to this embodiment can also realize extension of the abutting member 233 by operating the control knob 234 in a simple manner. In addition, when the abutting member 233 is in the extended position, the locking assembly 238 can be used to lock the extended state, so as to prevent the abutting member 233 from being retracted unexpectedly. Moreover, when disassembling and position adjustment are necessary, the locking assembly 238 can be unlocked in a simple manner to realize an automatic retraction of the abutting member 233.

The remaining undescribed parts of this embodiment are as same as those of the first embodiment, and will not be repeated for brevity.

### Third Embodiment

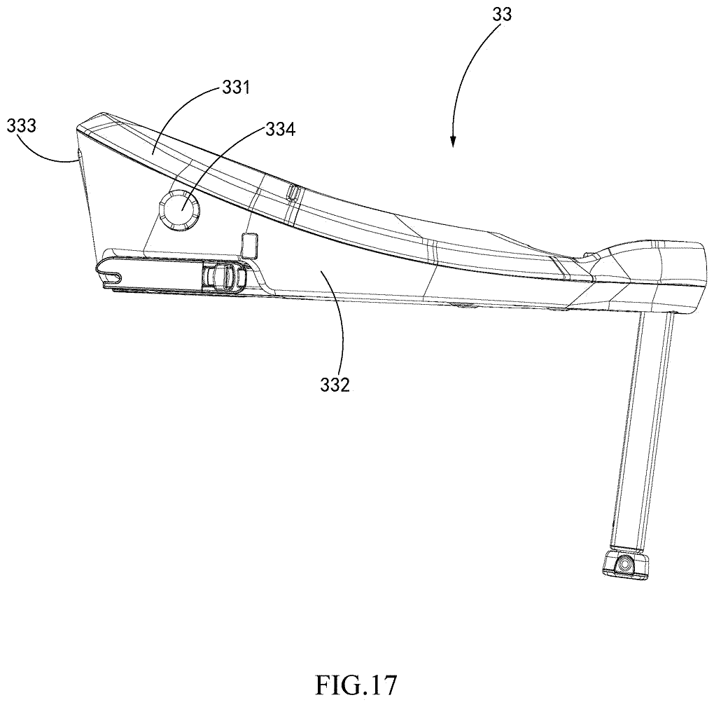

The third embodiment according to the application will be described below by referring to FIGS. 17-22. The components in the third embodiment which are different from those in the first embodiment as well as their connection relationships and operation modes will be emphatically described below.

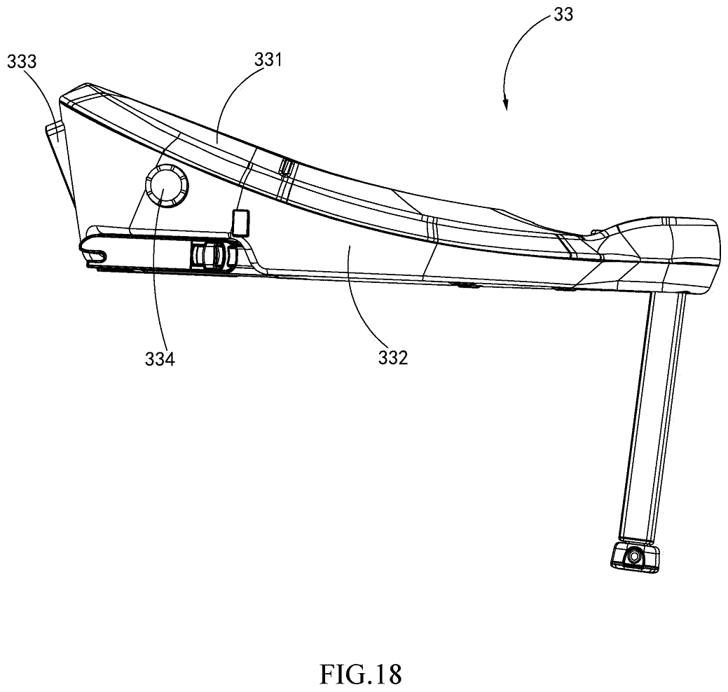

Referring to FIGS. 17, 18, the abutting and bearing device 33 according to third embodiment also includes an upper cover 331 and a lower cover 332. An abutting member 333 extends from the lower cover 332 and is located its extended position under driving of the driving assembly 335, and can be in its retracted position by unlocking and resetting of the resetting assembly 339. The extension and retraction movements of the abutting member in the first and second embodiments both are translational movements, while in this embodiment, the abutting member 333 is located in its extended position or retracted position by pivotal movement. FIG. 17 shows the abutting member 333 in a retracted state, and FIG. 18 shows the abutting member 333 in an extended state.

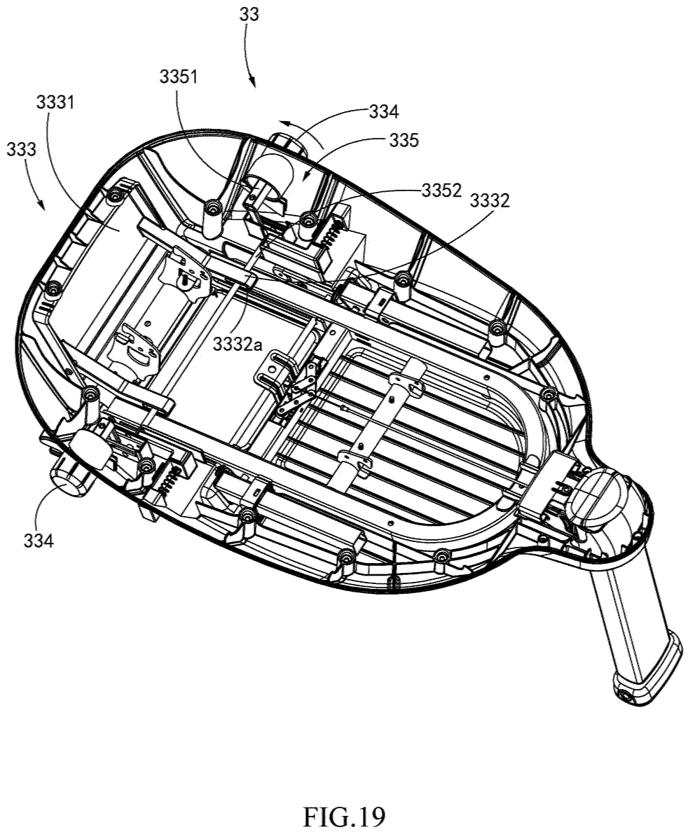

Referring to FIG. 19, the specific structures of the driving assembly 335 and the abutting member 333 of the abutting and bearing device 33 according to the third embodiment of the application will be described. The driving assembly 335 includes a driving member 3351 and a connecting arm 3352. The driving member 3351 is connected to the control knob 334, and the connecting arm 3352 is slidably connected to the abutting member 333 so that the abutting member 333 can pivotally move. Specifically, the abutting member 333 includes an abutting end 3331 and a connecting end 3332, and the connecting end 3332 includes a slot 3332a. The connecting arm 3352 spans the left and right sides of the connecting end 3332, and is arranged in the slot 3332a on the left and right sides of the connecting end 3332.

If the control knob 334 is rotated in the direction of the arrow shown in FIG. 19, the connecting arm 3352 is brought to move upward by the driving member 3351, and at this time, the connecting arm 3352 slides in the slot 3332a, such that the abutting member 333 is pivoted outward into its extended position.

According to the shown embodiment, the connecting arm 3352 may also be a cross bar connecting the two control knobs 334, such that the actions of the two control knobs 334 are synchronized.

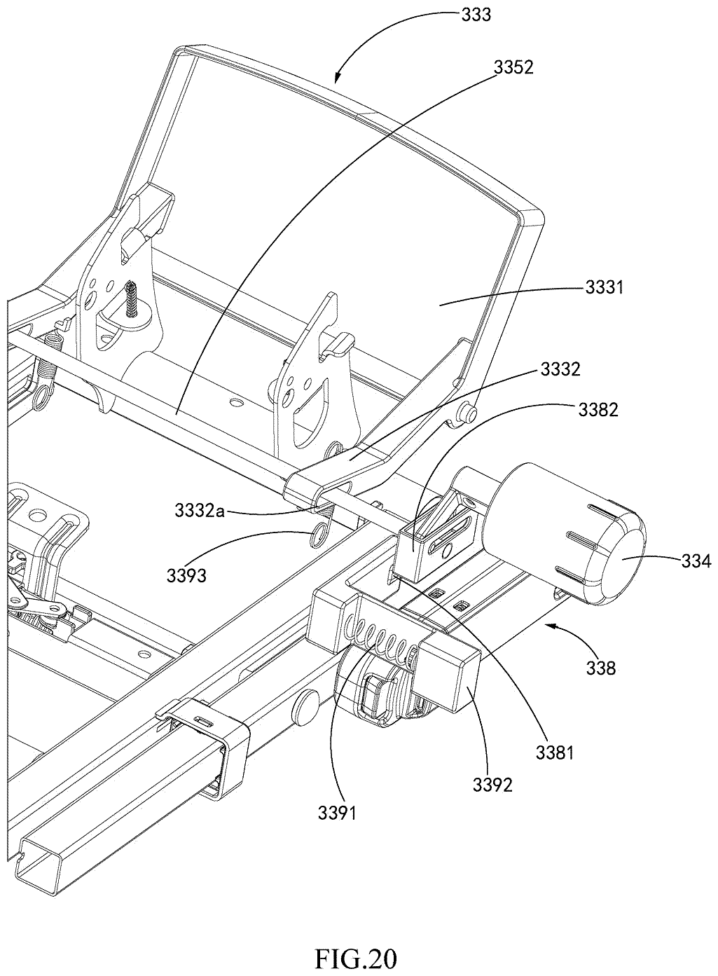

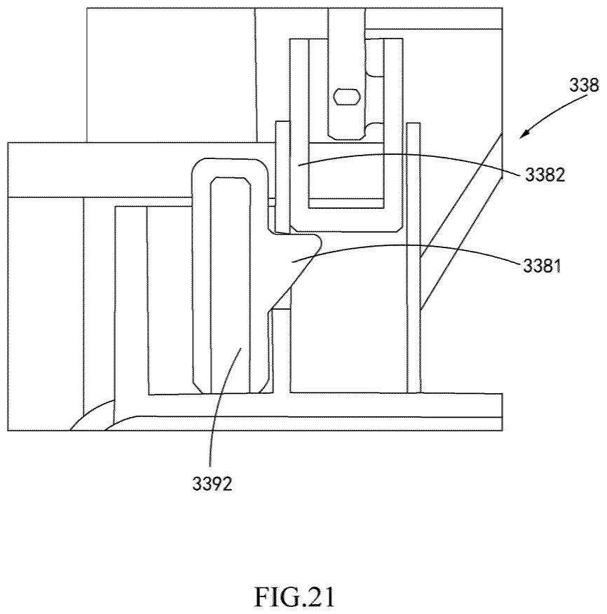

Hereinafter, referring to FIGS. 20 and 21 again, the structure of the locking assembly 338 of the abutting and bearing device 33 according to the third embodiment of the application will be described. The locking assembly 338 includes a locking block 3382 arranged on the lower cover 332 and a locking protrusion 3381 cooperative with the locking block 3382. When the control knob 334 operates the driving assembly 335 so that the abutting member 333 is in the extended position, the locking protrusion 3381 abuts against a lower end of the locking block 3382, thereby locking the abutting member 333 to the extended position.

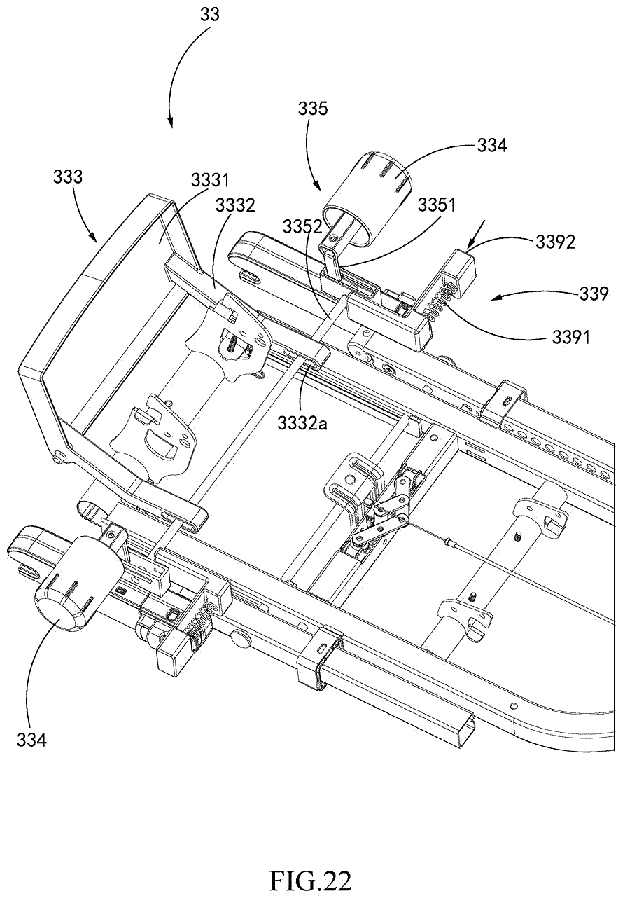

FIG. 22 is a schematic view showing the resetting assembly 339 of the abutting and bearing device 33 according to the third embodiment of the application. As shown in this figure, the resetting assembly 339 includes a push button 3392 and a resetting spring 3393 (see FIG. 20), and the locking protrusion 3381 is arranged on the push button 3392. One end of the resetting spring 3393 is connected to the abutting member 333, and the other end of the resetting spring 3393 is connected to the lower cover 332. The resetting spring 3393 keeps the state of pulling back of the abutting member 333 in normal state. In addition, the resetting assembly 339 further includes a push button spring 3391 disposed on the push button 3392. The push button spring 3391 provides a return function of the push button 3392.

Based on the third embodiment of the application, when the abutting member 333 needs to be reset, referring to FIGS. 20 and 22, the push button 3392 may be pushed in the direction of the arrow shown in FIG. 22, and the push button 3392 brings the locking protrusion 3381 on it to move together, thereby disengaging the locking block 3382, and realizing unlocking of the abutting member 333. In such state, the abutting member 333 is reset to be in the retracted position by the pulling of the resetting spring 3393.

The abutting and bearing device 33 according to this embodiment can also realize the extension of the abutting member 333 by operating the control knob 334 in a simple manner. In addition, when the abutting member 333 is in the extended position, the extended state may be locked by using the locking assembly 338, so as to avoid the abutting member 333 being retracted unexpectedly. Moreover, when it is necessary to carry out disassembling and performing position adjustment, the locking assembly 338 can be unlocked in a simple manner, thus realizing automatic retraction of the abutting member 333.

The remaining undescribed parts of this embodiment are as same as those of the first embodiment, and will not be repeated for brevity

### Fourth Embodiment

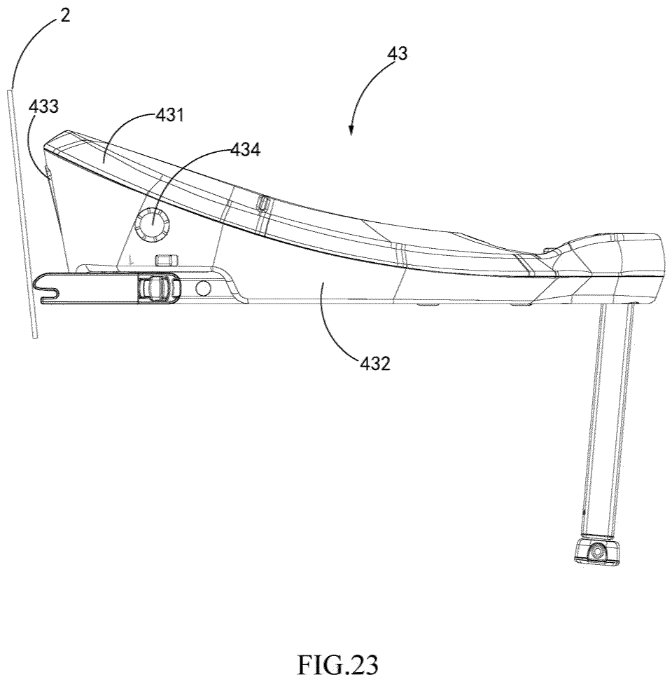

The fourth embodiment according to the application will be described below by referring to FIGS. 23-27. The components in the fourth embodiment which are different from those in the third embodiment as well as their connection relationships and operation modes will be emphatically described below.

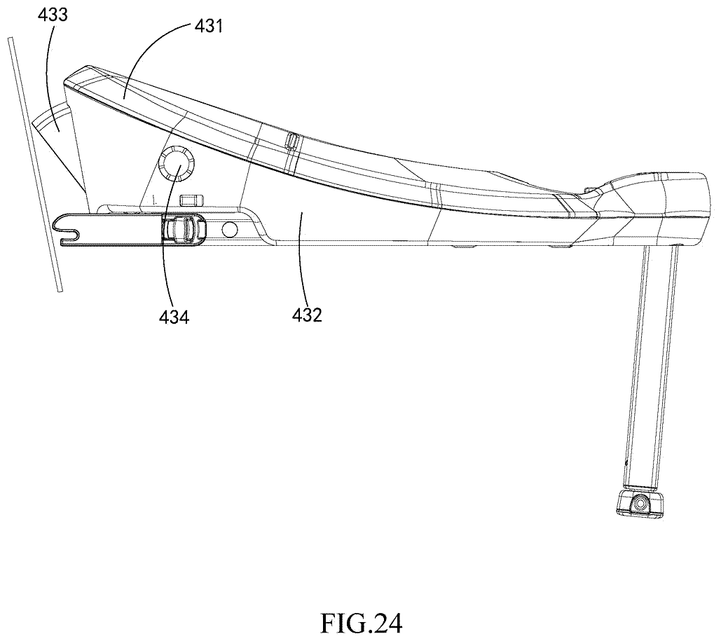

Referring to FIGS. 23, 24, the abutting and bearing device 43 according to the fourth embodiment also includes an upper cover 431 and a lower cover 432. An abutting member 433 extends from the lower cover 432, and can be in its extended position under driving of the driving assembly 435, and can be in its retracted position by unlocking and resetting of the resetting assembly 439. In this embodiment, as in the third embodiment, the abutting member 433 is also pivotally moved so as to be in its extended position or retracted position. FIG. 23 shows the abutting member 433 in a retracted state, FIG. 24 shows the abutting member 433 in an extended state.

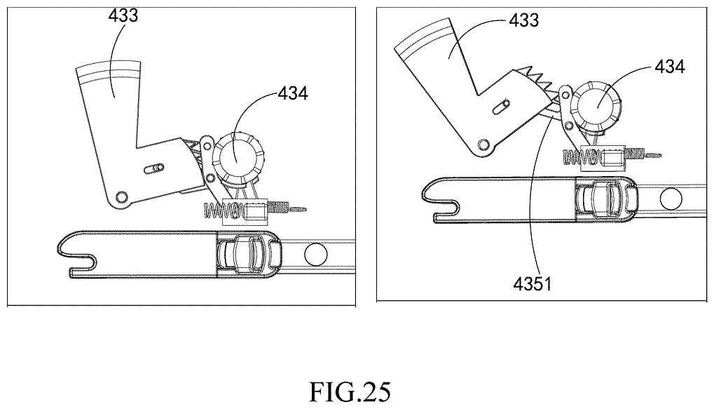

FIG. 25 shows a simplified structure of the abutting and bearing device 43 according to the fourth embodiment of the application, and shows the abutting member 433 in different states.

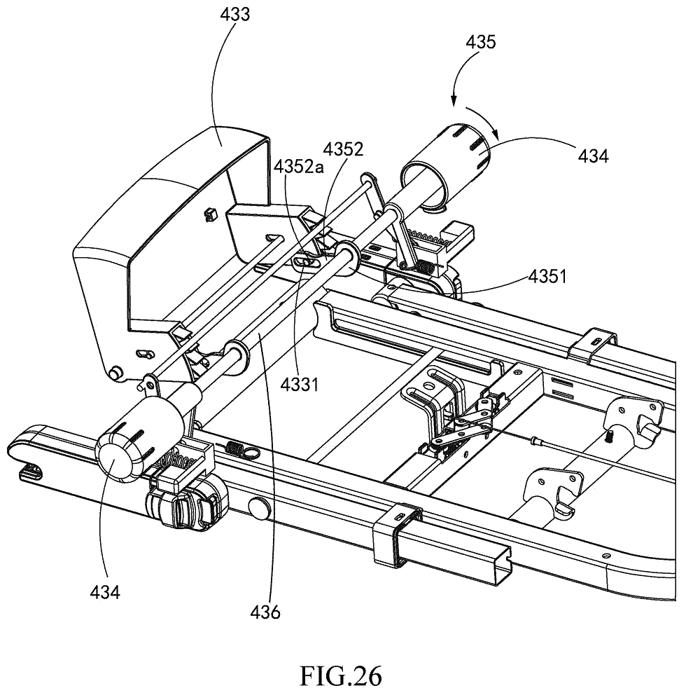

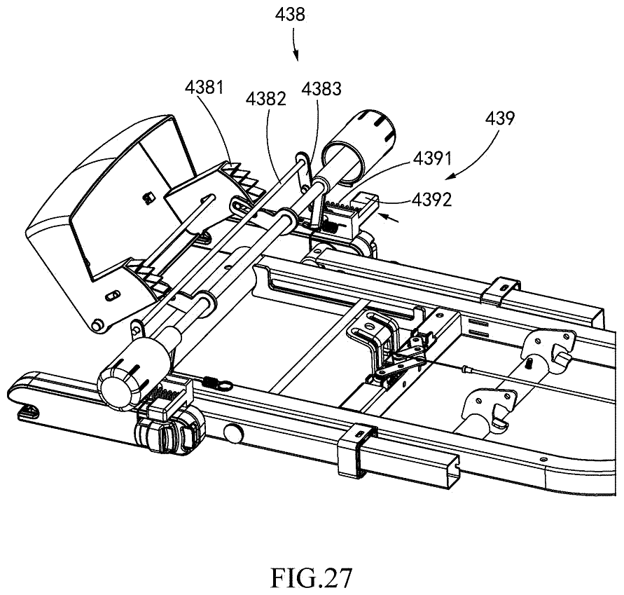

The specific structures and action modes of the locking assembly 438 and the resetting assembly 439 of the abutting and bearing device 43 according to the fourth embodiment will be described in detail below by referring to FIGS. 26 and 27. Among them, FIG. 26 shows the abutting member 433 in a retracted state, and FIG. 27 shows the abutting member 433 in an extended state.

The driving assembly 435 of the fourth embodiment includes a driving member 4351 and a connecting member 4352 fixedly connected to each other. The driving member 4351 is connected to a control knob 434, and the connecting member 4352 is connected to the abutting member 433 so that the abutting member 433 can pivotally move. According to the preferred embodiment shown in FIG. 26, the driving member 4351 and the connecting member 4352 are integrally formed. In addition, preferably, according to the shown embodiment, the control knob 434 is provided by two, and a cross bar 436 is arranged between the two control knobs 434, furthermore, the driving member 4351 of the driving assembly 435 is connected to the cross bar 436.

The abutting member 433 is L-shaped, and a pin 4331 is disposed at a lower end of the abutting member 433. A slot 4352a is arranged on the connecting member 4352, and the pin 4331 is inserted through the slot 4352a. Of course, the abutting member 433 may also be in other forms.

Based on the above structure, when the control knobs 434 are rotated in the direction of the arrow shown in FIG. 26, the driving member 4351 and the connecting member 4352 are brought to rotate upward together, and the pin 4331 of the abutting member 433 moves along the slot 4352a of the connecting member 4352, thereby causing the abutting member 433 to be pivoted outward in its extended position.

The locking assembly 438 according to the fourth embodiment includes a locking member 4381, a locking rod 4382, and a driving rod 4383. The locking member 4381 is connected to the abutting member 433. The locking member 4381 is cooperative with the locking rod 4382 through the driving rod 4383, such that the locking rod 4382 may be locked to the locking member 4381 or unlocked from the locking member 4381 through a pivoting of the driving rod 4383. According to this embodiment, the locking member 4381 includes a plurality of toothed slots to provide a plurality of different setting positions for cooperatively accommodating the locking rod 4382.

As described above, when the abutting member 433 is in its extended position, as shown in FIG. 27, the locking rod 4382 is under the locking member 4381 and is blocked, thereby locking the extended state of the abutting member 433.

The resetting assembly 439 according to the fourth embodiment includes a push button 4392 and a resetting spring 4391. The driving rod 4383 of the locking assembly 438 is connected to the push button 4392. One end of the resetting spring 4391 is connected to a transmission rod 437 which is connected to the cross bar 436, and then indirectly connected to the abutting member 433 through the driving assembly 435 which is also connected to the cross bar 436; and the other end of the resetting spring 4391 is connected to the lower cover 432 (which is shown in FIG. 24). Moreover, the resetting spring 4391 normally maintains the state of pulling back the abutting member 433. The driving rod 4383 is pivoted by pushing the push button 4392, such that the locking rod 4382 is unlocked from the locking member 4381. The resetting spring 4391 further comprises a push button spring 4392 which is provided at the push button 4392, for providing the function of resetting the push button 4392.

In view of the above structure, when the push button 4392 is pushed in the direction indicated by the arrow in FIG. 27, the locking rod 4382 is pulled back so as to be released from the state locked with the locking member 4381. In such case, by turning the control knobs 434, the push-out of the abutting member 433 can be adjusted; if the control knobs 434 is not turned, the abutting member 433 can be pulled back by the resetting spring 4391. On the other hand, when the push button 4392 is released, the push button spring 4393 would push the push button 4392 back to the original position, thereby driving the locking rod 4382 to reset, that is, to be locked with the locking member 4381. At this time, the position of the abutting member 433 cannot be adjusted by rotating the control knobs 434.

The abutting and bearing device 43 according to this embodiment can also realize extension of the abutting member 433 by operating the control knobs 434. In addition, when the abutting member 433 is in the extended position, such extended state can be locked by the locking assembly 438, so as to avoid the abutting member 433 being retracted unexpectedly. While it is necessary to carry out disassembling and perform position adjustment, the locking assembly 438 can be unlocked in a simple manner, so as to realize an automatic retraction of the abutting member 433.

The remaining undescribed parts of this embodiment are as same as those of the first embodiment, and will not be repeated for brevity.

### Fifth Embodiment

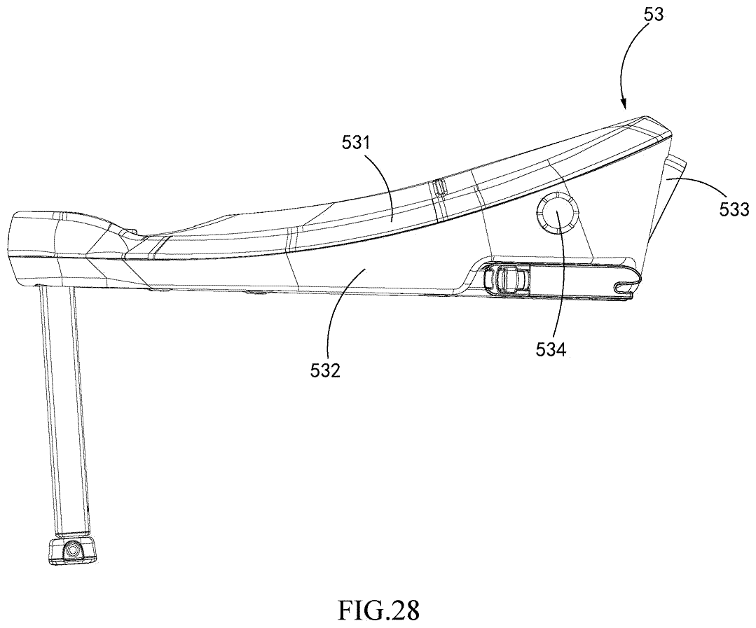

The fifth embodiment according to the application will be described below by referring to FIGS. 28-32. The components in the fifth embodiment which are different from those in the third embodiment as well as their connection relationships and operation modes will be emphatically described below.

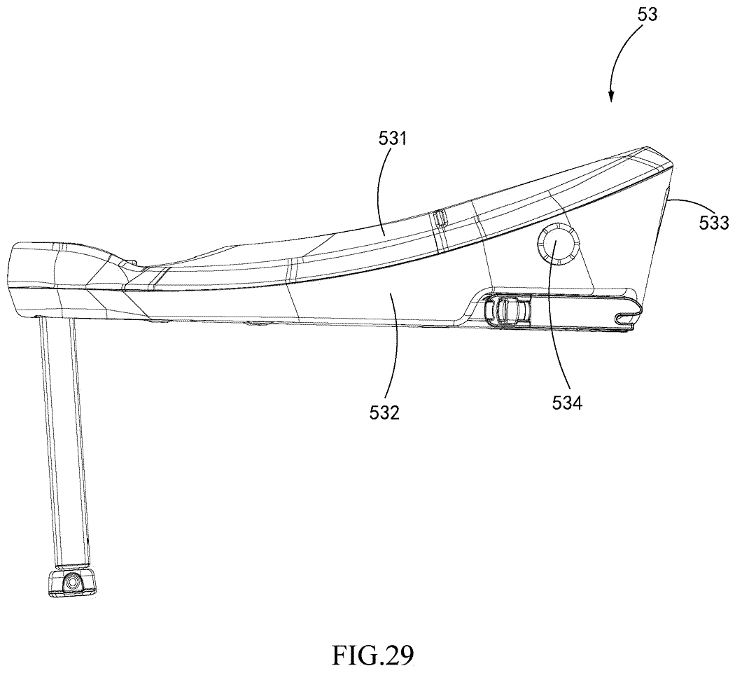

Referring to FIGS. 28, 29, the abutting and bearing device 53 according to the fifth embodiment also includes an upper cover 531 and a lower cover 532. An abutting member 533 extends from the lower cover 532, and can be in its extended position under driving of the driving member 535. In this embodiment, as in the third embodiment, the abutting member 533 is also pivotally moved to be in its extended position or retracted position. FIG. 28 shows that the abutting member 533 is in an extended state, FIG. 29 shows that the abutting member 533 is in the retracted state.

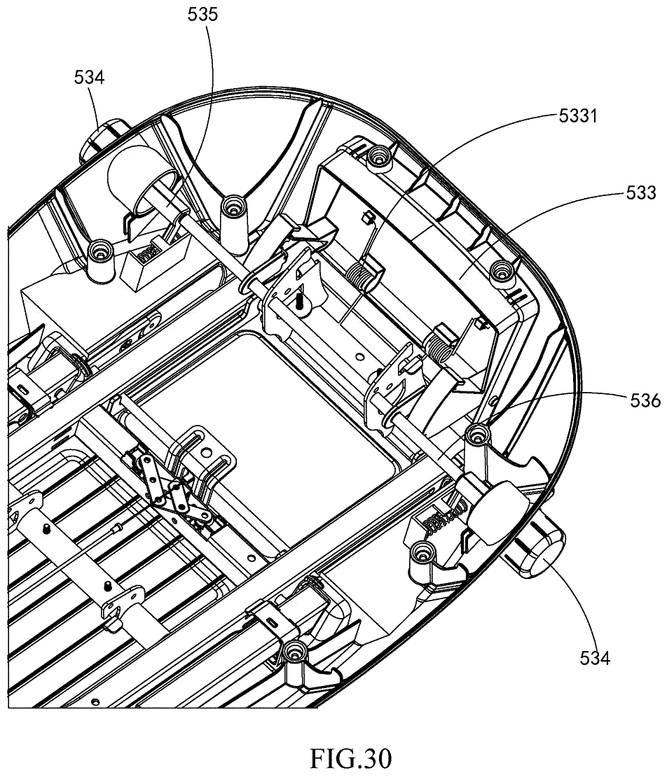

As shown in FIG. 30, which is a schematic view showing the structure of the driving member 535 of the abutting and bearing device 53 according to the fifth embodiment of the application. The abutting member 533 according to this embodiment includes an abutting member torsion spring 5331. One end of the abutting member torsion spring 5331 is connected to the abutting member 533, and the other end of the abutting member torsion spring 5331 is connected to the lower cover 532. Moreover, under normal conditions, the abutting member torsion spring 5331 is in a state pushing the abutting member 533 outwardly. Preferably, two control knobs 534 are provided in the fifth embodiment, and a cross bar 536 is provided between the two control knobs 534 to synchronize the actions of the two control knobs 534. Preferably, the cross bar 536 is connected to the control knobs 534 and a locking member 5381 (described in detail below), thus constituting the driving member 535.

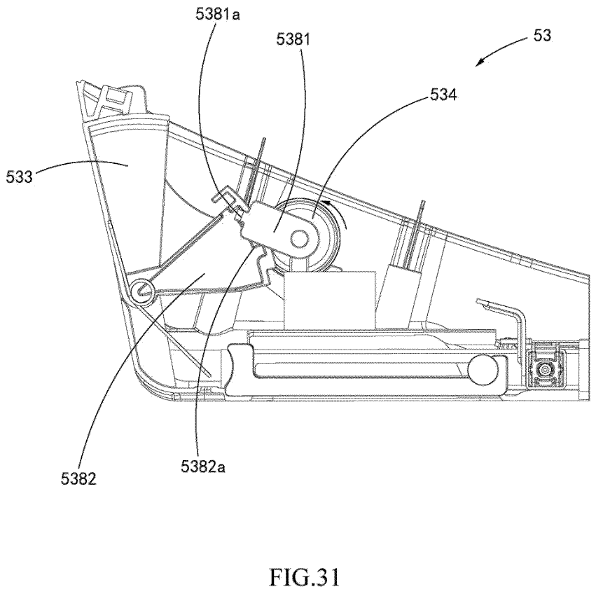

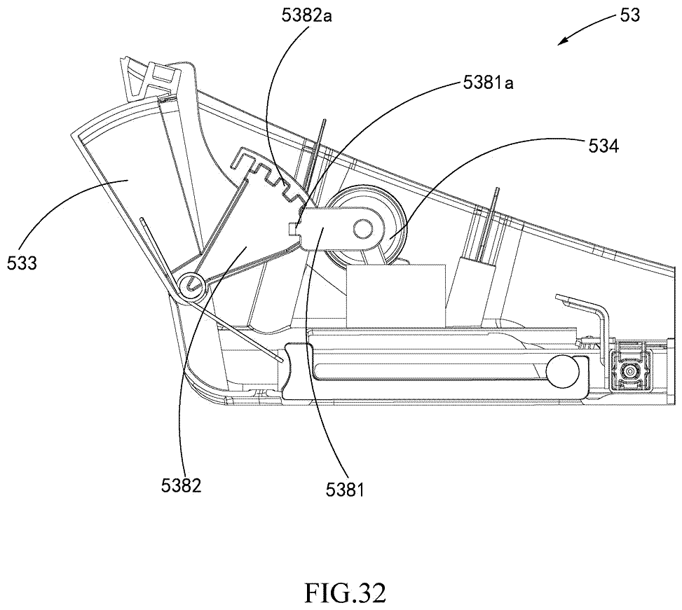

As shown in FIGS. 31 and 32, which are schematic views showing the structure of the locking assembly 538 of the abutting and bearing device 53 according to the fifth embodiment of the application, wherein the locking assembly 538 in FIGS. 31 and 32 are in different working positions. The locking assembly 538 according to this embodiment includes a locking member 5381 and a locking engagement member 5382, wherein the locking member 5381 is disposed on the cross bar 536, and the locking engagement member 5382 is disposed on the abutting member 533. In addition, the locking member 5381 includes a locking lug 5381a, and the locking engagement member 5382 includes a segment hole 5382a. The locking lug 5381a can be locked in the segment hole 5382a. Preferably, the segment hole 5382a can be provided by a plurality, so as to lock the locking lug 5381a at different setting positions.

Based on this embodiment, when the control knob 534 is rotated in the direction of the arrow shown in FIG. 31, the control knob 534 brings the driving member 535 to rotate, the driving member 535 brings the cross bar 536 to rotate, and the cross bar 536 brings the locking member 5381 to rotate counterclockwise to be released from locking with the segment hole 5382a. In such state, under pushing force of the torsion spring 5331 of the abutting member, the abutting member 533 is pivoted outwardly so as to be in its extended position.

The abutting and bearing device 53 according to this embodiment can realize extending of the abutting member 533 by operating the control knob 534 in a simple manner, such that the child safety seat 1 and the car seat back 2 can be tightly fitted to each other, so as to avoid the overturning accident of the child safety seat and improve safety.

The remaining undescribed parts of this embodiment are as same as those of the first embodiment, and will not be repeated for brevity.

According to the fifth embodiment, a base abutment device is provided, comprising: a base; an abutting member and a driving member which are disposed in the base, an end of the abutting member extends out of the base, and the abutting member can be moved by the driving member so as to be in its extended position or retracted position; a control member disposed on the base for controlling extension of the abutting member, wherein the base abutment device further includes a locking assembly for locking the abutting member when the abutting member is extended.

Wherein the base includes a base upper cover and a base lower cover connected to each other.

Wherein the control member is a control knob, a control push button, or a control button.

Wherein the control member is provided by two, and a cross bar is disposed between the two control members.

Wherein the cross bar is connected to the control member and the locking member to constitute the driving member.

Wherein the abutting member includes an abutting member torsion spring, one end of the abutting member torsion spring is connected to the abutting member, and the other end of the abutting member torsion spring is connected to the base.

Wherein the locking assembly includes a locking member and a locking engagement member, the locking member includes a locking member lug at its end, the locking engagement member includes a segment hole at its end, and the locking member lug be engaged with the segment hole.

Wherein the segment hole is provided by a plurality.

Since the features of the disclosure can be embodied in various forms without departing from the characteristics of the disclosure, it should also be understood, the above embodiments are not limited to any details described above, unless otherwise noted; rather, it should be interpreted broadly as being within the scope defined by the appended claims. Therefore, all modifications and variations falling within the scope and limits of the claims or equivalent solutions of such scope and limits shall be covered by the appended claims.

### LIST OF REFERENCE SIGNS

1: child safety seat
   10: body
2: car seat back
First Embodiment:
13: abutting and bearing device
   131: upper cover
   132: lower cover
   133: abutting rod assembly
      1331: abutting member
         1331a: inclined slot
      1332: sliding sleeve
         1332a: pin
      1333: abutting spring
   134: control knob
   135: driving assembly
      1351: driving member
      1352: connecting arm
         1352a: slot
   136: cross bar
   137: fixing member
   138: locking assembly
      1381: locking member
         1381a: first beveled edge
         1381b: sliding pin
      1382: locking groove
         1382a: second beveled edge
   139: resetting assembly
      1391: torsion spring
Second Embodiment:
23: abutting and bearing device
   231: upper cover
   232: lower cover
   233: abutting member
      2331: pin
   234: control knob
   235: driving assembly
      2351: driving member
      2352: connecting arm
         2352a: slot
   236: cross bar
   238: locking assembly
      2381: locking member
      2382: locking groove
   239: resetting assembly
      2391: resetting button
      2392: traction member
      2393: torsion spring
      2394: button reset spring
Third Embodiment:
33: abutting and bearing device
   331: upper cover
   332: lower cover
   333: abutting member
      3331: abutting end
      3332: connecting end
         3332a: slot
   334: control knob
   335: driving assembly
      3351: driving member
      3352: connecting arm
   338: locking assembly
      3381: locking protrusion
      3382: locking block
   339: resetting assembly
      3391: push button spring
      3392: push button
      3393: resetting spring
Fourth Embodiment:
43: abutting and bearing device
   431: upper cover
   432: lower cover
   433: abutting member
      4331: pin
   434: control knob
   435: driving assembly
      4351: driving member
      4352: connecting member
         4352a: slot
   436: cross bar
   438: locking assembly
      4381: locking member
      4382: locking rod
      438: driving rod
   439: resetting assembly
      4391: resetting spring
      4392: push button
Fifth Embodiment:
53: abutting and bearing device
   531: upper cover
   532: lower cover
   533: abutting member
5331: abutting member torsion spring
534: control knob
535: driving member
536: cross bar
538: locking assembly
   5381: locking member
      5381a: locking lug
      5382: locking engagement member
         5382a: segment hole

1. An abutting and bearing device, comprising:
a casing;
an abutting member disposed in the casing and having an end extending out of the casing;
a driving assembly disposed in the casing, and the abutting member being movable so as to be in its extended position or retracted position by the driving assembly; and
a control member disposed on the casing for controlling an extension of the abutting member;
wherein the abutting and bearing device further comprises a locking assembly and a resetting assembly, the locking assembly is used to lock the abutting member when the abutting member is extended, and the resetting assembly is used to reset the abutting member to its retracted position.

2-4. (canceled)

5. The abutting and bearing device according to claim 1, wherein the driving assembly comprises a driving member and a connecting arm, the driving member is connected to the control member, the connecting arm is connected to the abutting member so that the abutting member is able to move in translation, and the driving member is pivotally connected to the connecting arm.

6. (canceled)

7. The abutting and bearing device according to claim 5, wherein a sliding sleeve is covered on an outer side of the abutting member, and an abutting spring is disposed between the abutting member and the sliding sleeve.

8. The abutting and bearing device according to claim 7, wherein the sliding sleeve is connected to the connecting arm, and a pin is disposed on the sliding sleeve at a position where the sliding sleeve is connected to the connecting arm, the connecting arm comprises a slot, the pin is installed in the slot, the abutting member is pushed out or pulled back as the pin slides in the slot, when the abutting member is pushed out, the abutting spring is in a compressed state, the locking assembly comprises a locking member and a locking groove, the locking member is connected to the abutting member, and the locking groove is arranged on the casing.

9. The abutting and bearing device according to claim 5, wherein the abutting member is connected to the connecting arm, and a pin is disposed on the abutting member at a position where the abutting member is connected to the connecting arm, the connecting arm comprises a slot, and the pin is installed in the slot.

10. The abutting and bearing device according to claim 8, wherein the locking member has a first beveled edge, the locking groove has a second beveled edge cooperative with the first beveled edge, and when the locking member falls into or slides out of the locking groove, the first beveled edge slides along the second beveled edge.

11. (canceled)

12. The abutting and bearing device according to claim 8, wherein the locking member comprises a sliding pin, and the abutting member comprises an inclined slot, the sliding pin is able to slide in the inclined slot.

13. The abutting and bearing device according to claim 5, wherein the resetting assembly comprises a torsion spring, one end of the torsion spring is fixed on the casing, and the other end of the torsion spring is fixed on the driving member.

14. The abutting and bearing device according to claim 5, wherein the resetting assembly comprises a resetting button, a traction member and a torsion spring, the locking assembly comprises a locking member and a locking groove, the locking member is connected to the abutting member, and the locking groove is arranged on the casing, one end of the traction member is connected to the resetting button, and the other end of the traction member is connected to the locking member, one end of the torsion spring is fixed on the casing, and the other end of the torsion spring is fixed on the driving member.

15. The abutting and bearing device according to claim 14, wherein the resetting assembly further comprises a button reset spring disposed on the resetting button.

16. The abutting and bearing device according to claim 1, wherein the driving assembly comprises a driving member and a connecting arm, the driving member is connected to the control member, and the connecting arm is slidably connected to the abutting member so that the abutting member is able to pivotally move.

17. The abutting and bearing device according to claim 16, wherein the abutting member comprises an abutting end and a connecting end, the connecting end comprises a slot, and the connecting arm is arranged in the slot and can slide in the slot.

18. The abutting and bearing device according to claim 16, wherein the locking assembly comprises a locking block disposed on the casing, and a locking protrusion cooperative with the locking block, when the abutting member is in the extended position, the locking protrusion abuts against a lower end of the locking block, thereby locking the abutting member in the extended position.

19. The abutting and bearing device according to claim 18, wherein the resetting assembly comprises a push button and a resetting spring, the locking protrusion is arranged on the push button, one end of the resetting spring is connected to the abutting member, and the other end of the resetting spring is connected to the casing.

20. The abutting and bearing device according to claim 19, wherein the resetting assembly further comprises a push button spring disposed on the push button.

21-23. (canceled)

24. The abutting and bearing device according to claim 16, wherein the abutting member is L-shaped, and a lower end of the abutting member comprises a pin, the connecting member comprises a slot, and the pin is inserted through the slot and can move along the slot.

25. The abutting and bearing device according to claim 16, wherein the locking assembly comprises a locking member, a locking rod, and a driving rod, the locking member is connected to the abutting member, and the locking member cooperates with the locking rod through driving rod such that the locking rod is locked to or unlocked from the locking member through a pivoting of the driving rod.

26. The abutting and bearing device according to claim 25, wherein the locking member comprises a plurality of toothed slots for accommodating the locking rod.

27. The abutting and bearing device according to claim 25, wherein the resetting assembly comprises a push button and a resetting spring, the driving rod is connected to the push button, one end of the resetting spring is connected to the abutting member, the other end of the resetting spring is connected to the casing, and the resetting spring normally maintains a state of pulling back the abutting member, and the driving rod is pivoted by the push button, thereby unlocking the locking rod from the locking member.

28. A seating device, comprising a body and the abutting and bearing device according to claim 1, wherein the seating device is able to abut against a car seat back through the abutting and bearing device, and is able to be automatically unlocked from abutting against the car seat back.
